(19) United States
(12) Patent Application Publication
(10) Pub. No.: US 2025/0071622 A1
(43) Pub. Date: Feb. 27, 2025

(54) SYSTEMS, METHODS, AND DEVICES FOR MEDIUM RESERVATION MITIGATION FOR WIRELESS COMMUNICATION

(71) Applicant: Cypress Semiconductor Corporation, San Jose, CA (US)

(72) Inventors: Hyun Jong Lee, Seoul (KR); Chi Woo Lee, Namyangju-si (KR); Young San Kim, Deogyang-gu (KR); Heok Je Kim, Seoul (KR)

(73) Assignee: Cypress Semiconductor Corporation, San Jose, CA (US)

(21) Appl. No.: 18/453,005

(22) Filed: Aug. 21, 2023

(51) Int. Cl. H04W 28/26

(52) U.S. Cl. CPC H04W 28/26

(57) ABSTRACT

Systems, methods, and devices improve medium usage by wireless devices. Methods include monitoring, using one or more processing elements, one or more data throughput metrics associated with a first wireless device, and identifying, using the one or more processing elements, a presence of medium reservation activity associated with a second wireless device. Methods also include generating, using the one or more processing elements, a mitigation signal based, at least in part, on a designated data pattern, the mitigation signal comprising a plurality of mitigation data packets configured to reduce medium reservation by the first wireless. Methods further include transmitting the mitigation signal to the first wireless device.

### TECHNICAL FIELD

This disclosure relates to wireless communications and wireless devices, and more specifically, to enhancement of medium usage by such wireless devices.

### BACKGROUND

Wireless devices may be implemented in a variety of different operational contexts and may communicate with each other via one or more wireless communications channels. More specifically, a wireless device may be implemented in an automobile and may communicate with one or more components of the automobile. In one example, such a component may be a head unit of an infotainment system of the automobile. Accordingly, such wireless devices may be implemented in an environment that is mobile, and may enter and exit proximity of other wireless devices. Conventional implementation of such wireless devices and systems remain limited because they are not able to maintain efficient communications medium usage when encountering hidden nodes that exhibit medium reservation behavior.

### BRIEF DESCRIPTION OF THE DRAWINGS

FIG. 1 illustrates an example of a system for medium usage enhancement, configured in accordance with some embodiments.

FIG. 2 illustrates an example of a device for medium usage enhancement, configured in accordance with some embodiments.

FIG. 3 illustrates an example of a method for medium usage enhancement, performed in accordance with some embodiments.

FIG. 4 illustrates another example of a method for medium usage enhancement, performed in accordance with some embodiments.

FIG. 5 illustrates an additional example of a method for medium usage enhancement, performed in accordance with some embodiments.

FIG. 6 illustrates another example of a method for medium usage enhancement, performed in accordance with some embodiments.

FIG. 7 illustrates an example of a timing diagram associated with medium usage enhancement, performed in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as not to unnecessarily obscure the described concepts. While some concepts will be described in conjunction with the specific examples, it will be understood that these examples are not intended to be limiting.

Wireless devices may communicate with each other using one or more wireless communications protocols, such as a Wi-Fi protocol or a Bluetooth protocol. For example, wireless devices may communicate with each other using IEEE 802.11 or IEEE 802.15 wireless protocols. In a wireless environment, there may be many wireless devices that operate on different networks but share access to the same wireless channels. As disclosed herein, a wireless channel refers to a portion of a network medium used for communication (e.g., a frequency band). To reduce co-channel interference, wireless devices may use a channel in accordance with a carrier sense multiple access with collision avoidance (CSMA-CA) protocol.

The CSMA/CA protocol utilizes carrier sensing to avoid multiple wireless devices transmitting on the same channel at the same time. Carrier sensing detects whether a channel is idle or busy and includes physical carrier sensing and/or virtual carrier sensing. While physical carrier sensing detects whether the channel is busy due to a current frame, virtual carrier sensing detects whether the channel is busy or reserved for future frames to be transmitted immediately following the current frame.

Virtual carrier sensing allows wireless devices to reserve the channel for frames it intends to communicate. The reservation duration may be carried in the 802.11 media access control (MAC) header duration field, which is part of the MAC protocol data unit (MPDU) exchanged between MAC entities (e.g., of wireless devices). The duration value in the MAC header indicates the time required to complete the transmission of frames, including interframe spacing, after the current frame (e.g., the frame in which the duration value resides). The duration value represents one or more interframe spacings (e.g., short interframe spacing (SIFS)), and the time in microseconds for the intended recipient to communicate a one or more frames with the sender. Wireless devices that are able to decode the 802.11 MAC header extract the duration field value and save it as a network allocation vector (NAV) value to mark the medium as busy for the amount of time specified (e.g., in microseconds). The wireless device then counts down from the initial NAV value and may consider the channel to be busy or reserved for as long as the NAV value is non-zero.

Some devices may be considered “hog devices” that exhibit aggressive medium reservation activity. For example, components of a telecommunications infrastructure engaged in frequent transmissions of large amounts of data to numerous wireless devices may transmit many medium reservation packets which effectively “hog” usage of that wireless channel and result in inefficient usage of that wireless channel by other wireless devices using that wireless channel even if not connected to the network of the hog device. Conventional systems and devices are not able to efficiently identify the presence of such hog devices or counteract such aggressive medium reservation activity.

Embodiments disclosed herein provide the ability to detect the presence of medium reservation activity and generate a mitigation signal to reduce the effect of medium reservation activity, increase the efficiency of wireless communications medium usage, and increase data throughput of other wireless devices on that wireless channel. As will be discussed in greater detail below, various features of a wireless environment, such data throughput and location data, may be used to trigger the generation and implementation of mitigation operations to mitigate the impact of medium reservation activity of a hog device that might not be visible to the wireless devices, and may be a hidden node.

As will be discussed in greater detail below, mitigation operations may include the generation of a mitigation signal which may be configured to clear a local NAV value and cause a wireless device to switch to a different wireless channel. In various embodiments, the mitigation signal includes a frame transmitted at a selected time, power, length, direction, and/or frequency (e.g., using transmit beamforming or narrowband transmission) in order to interfere with the remote wireless device's ability to decode frames (e.g., reservations) sent by the hog device. In some embodiments, the mitigation signal may be a WLAN frame that causes a receiving wireless device to clear its own NAV. Such a frame may be a CFend frame or a vendor specific information element with instructions to ignore reservations sent by the hog device.

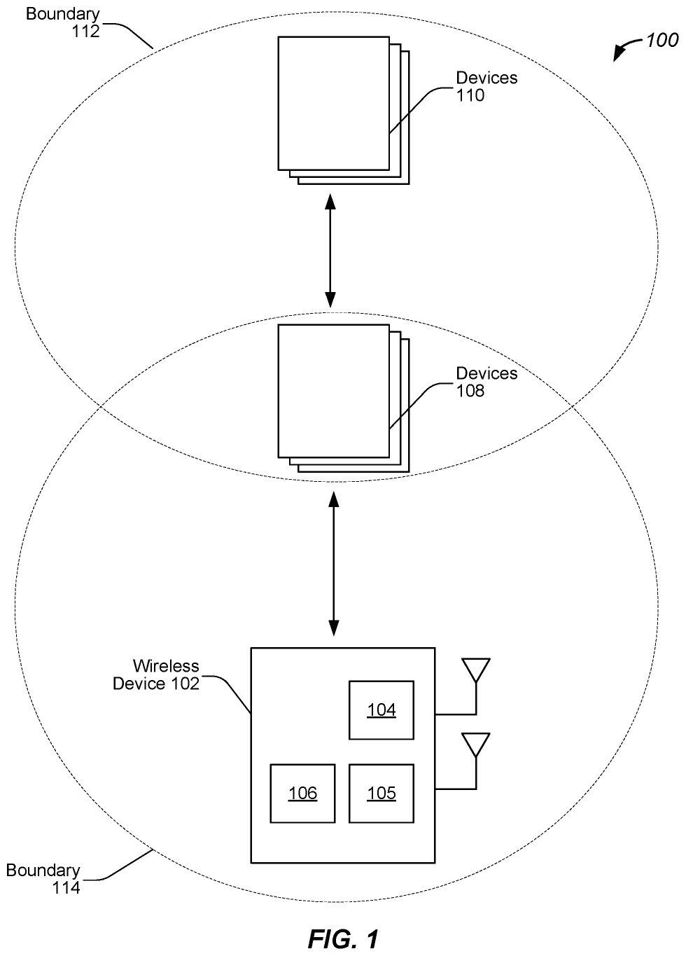

FIG. 1 illustrates an example of a system for medium usage enhancement, configured in accordance with some embodiments. Accordingly, a system, such as system 100, may include wireless devices that are used for wireless communications, and are also configured to be able to perform medium reservation mitigation operations as disclosed herein. Accordingly, as will be discussed in greater detail below, wireless devices included in system 100 may be configured to mitigate activity of nodes that might otherwise result in excessive medium reservation for various operations, such as data transmission operations for those other nodes.

Accordingly, system 100 includes wireless device 102 which may be a wireless communications device. As discussed above, such wireless devices may be compatible with one or more wireless transmission protocols, such as a Wi-Fi protocol or a Bluetooth protocol. In some embodiments, wireless device 102 includes collocated transceivers. For example, wireless device 102 may include a Wi-Fi transceiver and a Bluetooth transceiver that share access to a communications medium. For example, wireless device 102 may include a first transceiver, such as transceiver 104, and a second transceiver, such as transceiver 105. Transceiver 104 may be compatible with a Wi-Fi specification and protocol, and transceiver 105 may be compatible with a Bluetooth specification and protocol. For example, the Bluetooth protocol may be a Bluetooth Low Energy (BLE) protocol, also referred to as Bluetooth Smart. Moreover, wireless device 102 may include one or more antennas, and may also include processing device 106. As will be discussed in greater detail below, such processing devices and transceivers are configured to establish communications connections with other devices, and transmit data in the form of data packets via such communications connections.

In some embodiments, wireless device 102 may be a head unit included in an infotainment system of a vehicle, such as an automobile. Accordingly, wireless device 102 may be configured as an access point, and may be configured to communicate with various devices in an automobile environment, such as devices operated by passengers of the automobile. Wireless device 102 may also be configured to communicate with devices of other networks, such as other access points.

As discussed above, system 100 also includes devices 108 which are also wireless devices. More specifically, devices 108 may be compatible with one or more wireless transmission protocols, such as a Wi-Fi protocol or a Bluetooth protocol. In some embodiments, devices 108 may be configured as stations in communication with wireless device 102. Moreover, each of devices 108 may include one or more antennas, as well as processing devices and transceivers, which may also be configured to establish communications connections with other devices, and transmit data in the form of data packets via such communications connections.

In various embodiments, devices 108 are included in the vehicular environment associated with wireless device 102. For example, wireless device 102 may be a head unit of an infotainment system in an automobile, and devices 108 may be wireless devices such as a smart device or smartphone operated by a passenger within the automobile. It will be appreciated that devices 108 may be any suitable device, such as those found in cars, other vehicles, gaming systems, wearable devices, and even medical implants.

System 100 also includes devices 110 which are also wireless devices. In various embodiments, devices 110 are part of a wireless infrastructure, such as those that may be included in a Cambium network. Accordingly, devices 110 may be base stations or other components of a telecommunications network. Moreover, devices 110 may be configured as an access point to a larger communications network. Devices 110 may also include processing devices and transceivers compatible with one or more wireless transmission protocols, such as a Wi-Fi protocol. As will be discussed in greater detail below, devices 110 may transmit medium reservation packets to reserve a medium, such as a Wi-Fi channel, for data transmission operations associated with devices 110.

As shown in FIG. 1, devices 110 may be in communication with devices 108, but not with wireless device 102, as denoted by boundary 112. Moreover, wireless device 102 may be in communication with devices 108, but not with devices 110, as denoted by boundary 114. Accordingly, from the perspective of wireless device 102, a device included in devices 110 is a hidden node, and is not visible to wireless device 102. Accordingly, wireless device 102 is not aware of medium reservation activity of devices 110 that is affecting operation of devices 108. As will be discussed in greater detail below, wireless device 102 is configured to generate and implement a mitigation signal to mitigate the effects of such medium reservation activity.

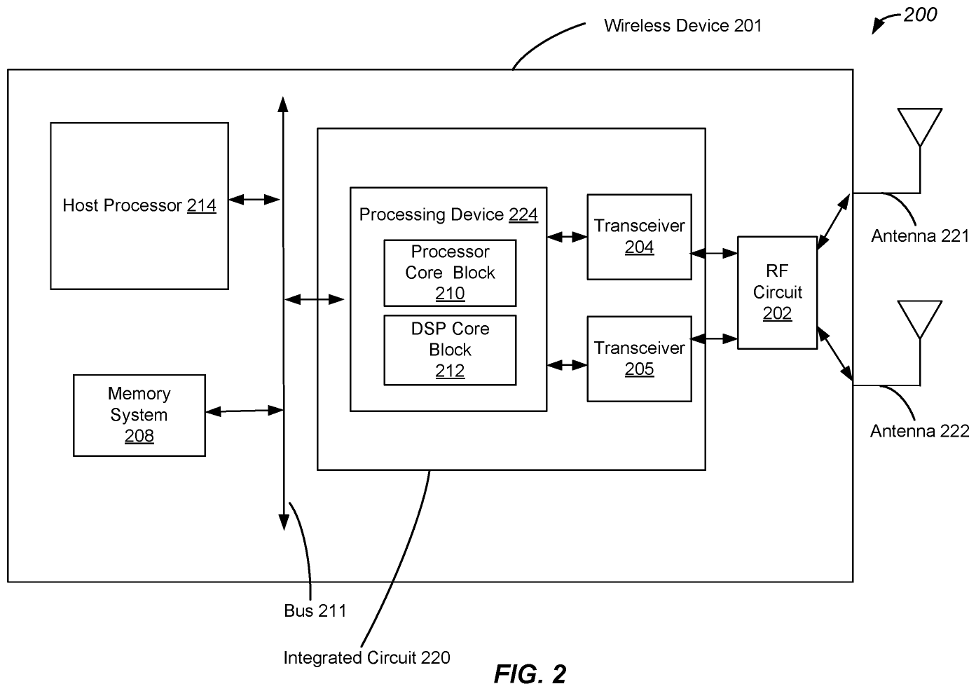

FIG. 2 illustrates an example of a device for medium usage enhancement, configured in accordance with some embodiments. More specifically, FIG. 2 illustrates an example of a system, such as system 200, that includes wireless device 201. It will be appreciated that wireless device 201 may be one of any of the wireless devices discussed above with reference to FIG. 1, such as wireless device 102, devices 108, and devices 110. Accordingly, wireless device 201 may be configured as a head unit of an infotainment system.

In various embodiments, system 200 includes one or more transceivers, such as transceiver 204 and transceiver 205. In one example, transceiver 204 is configured to transmit and receive signals using a communications medium that may include antenna 221 or antenna 222. As noted above, transceiver 204 may be a Wi-Fi transceiver. Accordingly, transceiver 204 may be compatible with a Wi-Fi communications protocol, such as an 802.11ax protocol. In various embodiments, transceiver 204 includes a modulator and demodulator as well as one or more buffers and filters, that are configured to generate and receive signals via antenna 221 and/or antenna 222.

System 200 additionally includes transceiver 205 which may be collocated with transceiver 204 in wireless device 201. In various embodiments, transceiver 205 is also be configured to transmit and receive signals using a communications medium that may include antenna 221 or antenna 222. Accordingly, transceiver 205 may be a Bluetooth transceiver compatible with a Bluetooth communications protocol. In one example, the Bluetooth protocol may be a Bluetooth Low Energy (BLE) protocol. Moreover, transceiver 205 includes a modulator and demodulator as well as one or more buffers and filters, that are configured to generate and receive signals via antenna 221 and/or antenna 222. While various embodiments are described with reference to Bluetooth and Wi-Fi communications protocols, it will be appreciated that any suitable protocol may be used.

In various embodiments, system 200 further includes processing device 224 which may include logic implemented using processing elements and/or one or more processor cores. Accordingly, processing device 224 is configured to implement mitigation signal generation operations, as will be discussed in greater detail below. In various embodiments, processing device 224 includes processing elements that are configured to implement such mitigation signal generation operations. For example, processing device 224 may be configured to implement a location tracker configured to support geolocation services as well as an application buffer monitor configured to perform buffer monitoring operations as disclosed herein. Moreover, processing device 224 includes one or more components configured to implement a medium access control (MAC) layer that is configured to control hardware associated with a wireless transmission medium, such as that associated with a Wi-Fi transmission medium. In one example, processing device 224 may include processor core block 210 that may be configured to implement a driver, such as a Bluetooth and/or Wi-Fi driver. Processing device 224 may further include digital signal processor (DSP) core block 212 which may be configured to include microcode.

In various embodiments, processor core block 210 comprises multiple processor cores which are each configured to implement specific portions of a wireless protocol interface. For example, a Bluetooth protocol may be implemented using a Bluetooth stack in which software is implemented as a stack of layers, and such layers are configured to compartmentalize specific functions utilized to implement the Bluetooth communications protocol. In various embodiments, a host stack includes layers for a Bluetooth network encapsulation protocol, radio frequency communication, service discovery protocol, as well as various other high level data layers. Moreover, a controller stack includes a link management protocol, a host controller interface, a link layer which may be a low energy link layer, as well as various other timing critical layers.

System 200 further includes radio frequency (RF) circuit 202 which is coupled to antenna 221 and antenna 222. In various embodiments, RF circuit 202 may include various components such as an RF switch, a diplexer, and a filter. While FIG. 2 illustrates system 200 as having two antennas, it will be appreciated that system 200 may have a single antenna, or any suitable number of antennas. Accordingly, RF circuit 202 may be configured to select an antenna for transmission/reception, and may be configured to provide coupling between the selected antenna, such as antenna 221, and other components of system 200 via a bus, such as bus 211. While one RF circuit is shown, it will be appreciated that wireless communications device 201 may include multiple RF circuits. Accordingly, each of multiple antennas may have its own RF circuit. Moreover, each one may be associated with a particular wireless communications protocol, such as a first antenna and RF circuit for Wi-Fi and a second antenna and RF circuit for Bluetooth.

System 200 includes memory system 208 which is configured to store one or more data values associated with mitigation signal generation operations discussed above and in greater detail below. Accordingly, memory system 208 includes storage device, which may be a non-volatile random access memory (NVRAM) or non-volatile static random access memory (NVSRAM) configured to store such data values, and may also include a cache that is configured to provide a local cache. In various embodiments, system 200 further includes host processor 214 which is configured to implement processing operations implemented by system 200.

It will be appreciated that one or more of the above-described components may be implemented on a single chip, or on different chips. For example, transceiver 204, transceiver 205, and processing device 224 may be implemented on the same integrated circuit chip, such as integrated circuit chip 220. In another example, transceiver 204, transceiver 205, and processing device 224 may each be implemented on their own chip, and thus may be disposed separately as a multi-chip module or on a common substrate such as a printed circuit board (PCB). It will also be appreciated that components of system 200 may be implemented in the context of a low energy device, a smart device, or a vehicle such as an automobile. Accordingly, some components, such as integrated chip 220, may be implemented in a first location, while other components, such as antenna 221, may be implemented in second location, and coupling between the two may be implemented via a coupler such as RF circuit 202.

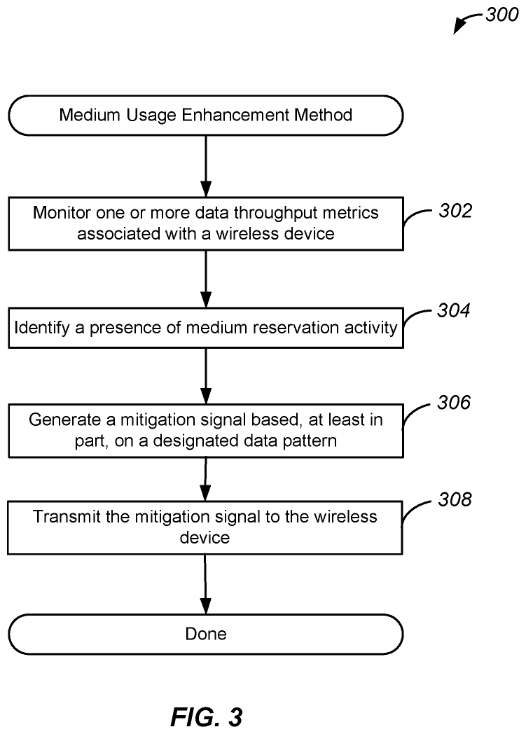

FIG. 3 illustrates an example of a method for medium usage enhancement, performed in accordance with some embodiments. Accordingly, a method, such as method 300, may be performed to implement medium reservation mitigation operations as disclosed herein. As will be discussed in greater detail below, such mitigation operations may include the generation of a mitigation signal that is used to mitigate effects of medium reservation operations performed by a hidden node.

Method 300 may perform operation 302 during which one or more data throughput metrics may be monitored. For example, an access point, which may be a head unit of an infotainment system, may communicate with another device, such as a smartphone, and may monitor one or more data throughput metrics associated with the device. In one example, the head unit may monitor a status of a application buffer to monitor how full or empty the application buffer is. Accordingly, during operation 302, the head unit may obtain one or more data values representing a data throughput of another wireless device, such as a smartphone.

Method 300 may perform operation 304 during which a presence of medium reservation activity may be identified. As similarly discussed above, the medium reservation activity may be associated with a hog device which may be performing medium reservation operations. As will be discussed in greater detail below, the identification of medium reservation activity may be made based on an identification of a threshold value crossing. In various embodiments, the threshold value may be a designated threshold value determined by an entity, such as a manufacturer or an administrator, and may represent a data throughput threshold value. As discussed above, in an example where an application buffer is monitored, the threshold value crossing may be identified when the contents of a buffer drop below a designated threshold level and the buffer is not sufficiently full. As will be discussed in greater detail below, such a reduction in data throughput may be caused by medium reservation activity of a hidden node, such as transmission of a long NAV packet.

Method 300 may perform operation 306 during which a mitigation signal may be generated. Accordingly, in response to identifying the threshold value crossing, a system component, such as a head unit, may generate a mitigation signal. As will be discussed in greater detail below, the mitigation signal may have a designated data pattern, and may be configured to clear a local NAV value, and cause the device to switch to a different wireless channel.

Method 300 may perform operation 308 during which the mitigation signal may be transmitted. Accordingly, the head unit may transmit the mitigation signal to the device to clear the local NAV value, and cause the device to switch to a different wireless channel. The mitigation signal may include mitigation packets forcibly sent in accordance with the designated data pattern. Accordingly, by forcing the device to clear a local NAV value and switch to a different wireless channel, effects of a medium reservation signal, which may include a long NAV packet, are mitigated due to termination of the NAV duration and switching to a different channel.

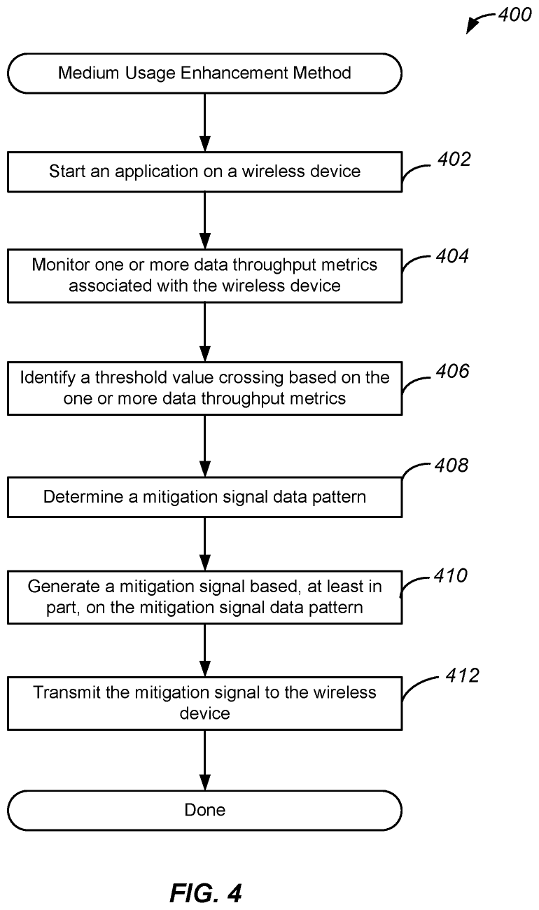

FIG. 4 illustrates another example of a method for medium usage enhancement, performed in accordance with some embodiments. Accordingly, a method, such as method 400, may be performed to implement medium reservation mitigation operations as disclosed herein. As will be discussed in greater detail below, such mitigation operations may include the monitoring of data throughput and/or signal quality metrics for wireless devices, and the generation of a mitigation signal that is used to mitigate effects of medium reservation operations performed by a hidden node.

Method 400 may perform operation 402 during which an application may be started. In various embodiments, the application is a software application executed on hardware of one or more devices, as similarly discussed above. More specifically, the application may be a software application configured to manage communications between wireless devices. Accordingly, the application may be executed on a system component, such as a head unit. Moreover, an additional instance of the application may execute on another wireless device, such as a smartphone, and the instances of the applications may communicate with each other to manage data transfers between the wireless devices with a unified interface.

In one example, the application may be an automotive-specific communications application, such as CarPlay or Android Auto. Accordingly, the application may include various components configured to facilitate communication between a wireless device, such as a smartphone, and various components of the automobile via the head unit, such as a stereo system. The application may also include components configured to assess wireless connections and generate wireless connection metrics. For example, the application may include a data throughput test tool configured to measure data throughput of the connection between, for example, the smartphone and the head unit.

Method 400 may perform operation 404 during which one or more data throughput metrics may be monitored. As similarly discussed above, an access point, which may be a head unit of an infotainment system, may communicate with another device, such as a smartphone, and may monitor one or more data throughput metrics associated with the device. As noted above, the monitoring may occur via a data throughput test tool that is part of the application. It will be appreciated that the monitoring may be performed by the either the instance of the application executed by the head unit, or the instance of the application executed by the smartphone. Accordingly, the application may generate data throughput metrics for the wireless connection managed by the application, and such data throughput metrics may be monitored by the application.

Method 400 may perform operation 406 during which a threshold value crossing may be identified. In various embodiments, the threshold value may be a designated threshold value determined by an entity, such as a manufacturer or an administrator, and may represent a data throughput threshold value. As discussed above, in an example where an application buffer is monitored, an indicator of data throughput may be determined based on a status of an application buffer. More specifically, a threshold value crossing may be identified when the contents of a buffer drop below a designated threshold level and the buffer is not sufficiently full.

In various embodiments, the application buffer is configured to store physical sensing information associated with the wireless connection managed by the application. If an amount of data stored in the buffer falls below a designated threshold value, it may be inferred that excessive medium reservation operations are occurring. More specifically, such a reduction in data throughput represented by the reduction of the application buffer level may be caused by medium reservation activity of a hidden node, such as transmission of a long NAV packet. It will be appreciated that other data throughput and signal quality metrics may be used as well. For example, such signal quality metrics may include received signal strength indicator (RSSI) values as well as signal-to-noise ratios (SNRs).

It will be appreciated that the application buffer may store other types of data which may have other associated metrics. For example, the application buffer may store video data for a display screen, touch screen event data, as well as other connection data and information. Data for other applications or multiple applications may be stored in the buffer as well. For example, navigation data, text and phone data, or any other type of data may also be stored in the buffer.

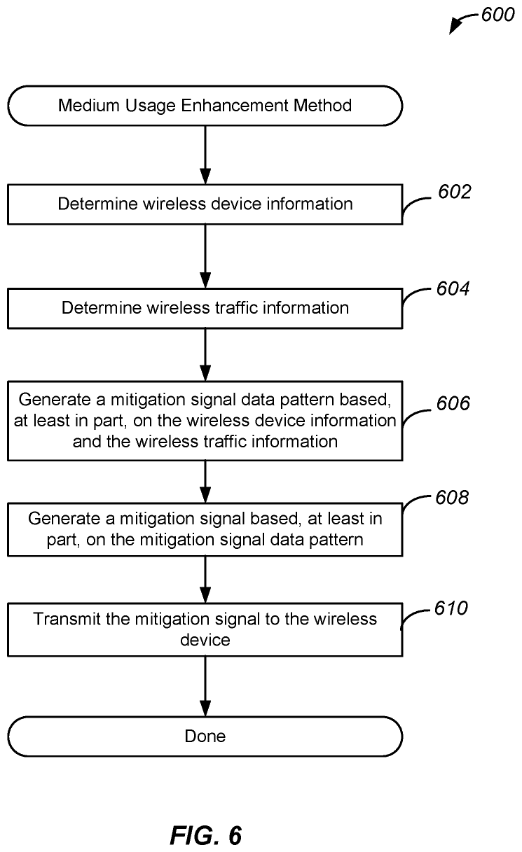

Method 400 may perform operation 408 during which a mitigation signal data pattern may be determined. In various embodiments, such a mitigation signal data pattern may have a designated periodicity as well as a designated duration for mitigation packets sent from the head unit to other wireless devices, such as the smartphone. As will be discussed in greater detail below with reference to FIG. 6, the designated periodicity and designated duration may be determined by an entity, such as a manufacturer or an administrator, and may be configured based on performance parameters of the head unit and the wireless device. In some embodiments, the mitigation packets have a fixed periodicity with a fixed amount of time between data packets. In various embodiments, the mitigation packets have a varying periodicity where an amount of time between data packets is varied by some amount by, for example, applying an amount of jitter to a fixed period.

Method 400 may perform operation 410 during which a mitigation signal may be generated. Accordingly, in response to identifying the threshold value crossing and in response to determining an appropriate mitigation signal data pattern, a system component, such as a head unit, may generate a mitigation signal. In various embodiments, the mitigation signal is configured to have a designated periodicity as well as a designated duration of several mitigation data packets. As discussed above, such mitigation data packets are configured to clear a local NAV value, and cause a receiving device to switch to a different wireless channel.

Method 400 may perform operation 412 during which the mitigation signal may be transmitted. Accordingly, the head unit may transmit the mitigation signal to the wireless device to clear the local NAV value, and cause the device to switch to a different wireless channel. As discussed above, the mitigation signal includes mitigation packets forcibly sent in accordance with the designated data pattern. Accordingly, by forcing the device to clear a local NAV value and switch to a different wireless channel, effects of a medium reservation signal, which may include a long NAV packet, are mitigated due to termination of the NAV duration and switching to a different channel.

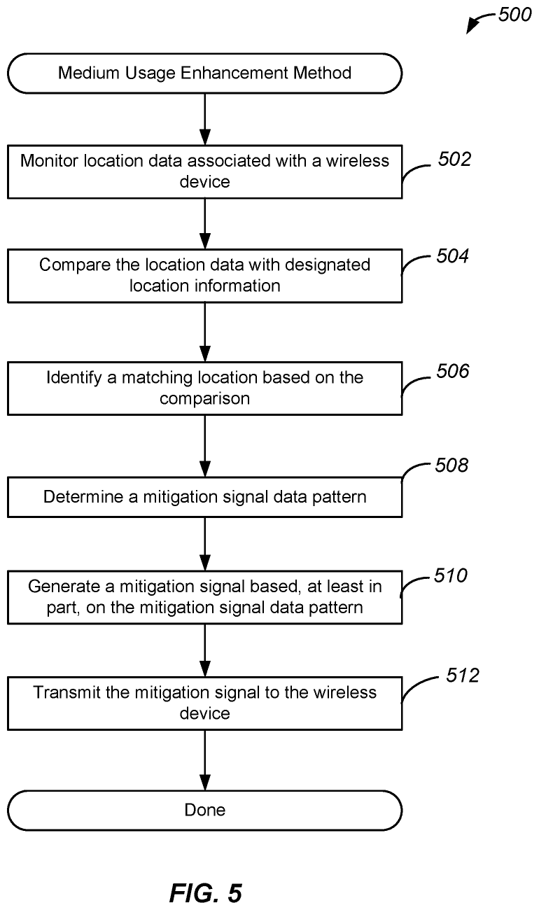

FIG. 5 illustrates an additional example of a method for medium usage enhancement, performed in accordance with some embodiments. Accordingly, a method, such as method 500, may be performed to implement medium reservation mitigation operations as disclosed herein. As will be discussed in greater detail below, such mitigation operations may include the monitoring of location information, and the generation of a mitigation signal based on such location information.

Method 500 may perform operation 502 during which location information associated with a wireless device may be monitored. In various embodiments, the location information is determined based on one or more location services that may be executed by the wireless device. For example, a location service executed by a head unit may have access to global positioning system (GPS) data of an automobile in which the head unit is implemented. In another example, such a location service may be executed on a wireless device, such as a smartphone, and may be communicated to the head unit via a wireless connection.

Method 500 may perform operation 504 during which the location data may be compared with designated location information. In various embodiments, the designated location information may be a database of locations populated by an entity, such as a manufacturer or administrator. The designated location information may include locations of devices known to generate overly-aggressive medium reservation operations. For example, a GPS location of base stations included in a telecommunications infrastructure may be known to a manufacturer. Accordingly, those GPS locations as well as a designated distance, as may be defined by a radius, from those GPS locations may be defined as designated location information. In various embodiments, the designated location information may be retrieved via a wireless connection, or may have been previously stored in memory as part of a software update or an installation and configuration procedure. In some embodiments, the designated location information may be updated to include newly identified locations. Accordingly, designated location information may be dynamically updated based on one or more other identified conditions, such as a decrease in data throughput or as part of a scheduled update. It will be appreciated that various other types of devices may be identified in designated location information as well. Accordingly, the designated location information may identify the location of multiple types of devices.

Method 500 may perform operation 506 during which a matching location may be identified based on the comparison. Accordingly, as discussed above, the location data that is continually monitored may be compared against the locations identified in the designated location information. A match may be determined based on one or more matching entries. For example, such a match may be a match in GPS coordinates of the location data and GPS coordinates included in a data entry of the designated location information. It will be appreciated that a match may be identified based on any suitable number of dimensions of data. For example, a match may be identified based on matching GPS coordinates as well as an additional data dimension of metadata, such as recency of a designated location information update, as indicated by a timestamp, or temporal data such as a current time of day. For example, some locations may only be identified as matches during business hours.

Method 500 may perform operation 508 during which a mitigation signal data pattern may be determined. As similarly discussed above, such a mitigation signal data pattern may have a designated periodicity as well as a designated duration for mitigation packets sent from the head unit to other wireless devices, such as the smartphone. As will be discussed in greater detail below, the mitigation packets may have a fixed periodicity with a fixed amount of time between data packets. In some embodiments, the mitigation packets may have a varying periodicity where an amount of time between data packets is varied by some amount by, for example, applying an amount of jitter to a fixed period of time.

Method 500 may perform operation 510 during which a mitigation signal may be generated. Accordingly, in response to identifying a location match and in response to determining an appropriate mitigation signal data pattern, a system component, such as a head unit, may generate a mitigation signal. In various embodiments, the mitigation signal is configured to have a designated periodicity as well as a designated duration of several mitigation data packets. As discussed above, such mitigation data packets are configured to clear a local NAV value, and cause a receiving device to switch to a different wireless channel.

Method 500 may perform operation 512 during which the mitigation signal may be transmitted. Accordingly, the head unit may transmit the mitigation signal to the wireless device to clear the local NAV value, and cause the device to switch to a different wireless channel. As discussed above, the mitigation signal includes mitigation packets forcibly sent in accordance with the designated data pattern. Accordingly, by forcing the device to clear a local NAV value and switch to a different wireless channel, effects of a medium reservation signal, which may include a long NAV packet, are mitigated due to termination of the NAV duration and switching to a different channel.

FIG. 6 illustrates another example of a method for medium usage enhancement, performed in accordance with some embodiments. Accordingly, a method, such as method 600, may be performed to implement medium reservation mitigation operations as disclosed herein. As will be discussed in greater detail below, such mitigation operations may include the monitoring of location information, and the generation of a mitigation signal based on such location information.

Method 600 may perform operation 602 during which wireless device information may be determined. In various embodiments, the wireless device information may include one or more identifiers configured to identify hardware and connection capabilities of a wireless device. The wireless device information may also include one or more performance metrics, such as signal quality metrics associated with the wireless device. For example, RSSI values and SNR values may be retrieved for various wireless channels of the wireless device.

Method 600 may perform operation 604 during which wireless traffic information may be determined. In various embodiments, the wireless traffic information may include log data representing previous network traffic of the wireless device. Such log data may be managed and stored by an application, such as an automotive application discussed above, and may identify periods of activity as well as periods of inactivity. Accordingly, such log data may identify active and inactive periods for the different wireless channels of the wireless device.

Method 600 may perform operation 606 during which a mitigation signal data pattern may be generated based, at least in part, on the wireless device information and the wireless traffic information. Accordingly, the retrieved data may be used to determine a data pattern that has the greatest data transmission efficiency and the highest data throughput. In one example, the log data may be analyzed to identify periods of inactivity, and a data pattern may be generated based on those identified periods of inactivity. More specifically, periodic inactivity may be used to infer periodic medium reservation operations performed by a hidden node, and also used to define a period for mitigation packets included in a mitigation signal.

In various embodiments, an offset from the periodic medium reservation operations may be determined by an entity, such as a manufacturer. For example, such aspects of the mitigation signal data pattern may be determined by an entity, such as a manufacturer, during device testing and configuration operations. Accordingly, a manufacturer may simulate activity of hidden node entity, such as a base station of a telecommunications infrastructure, and may determine which period and offset should be used for the mitigation signal data pattern based on testing a range of periods and offsets, and selecting the parameters that result in the highest data throughput for the wireless device under test.

In some embodiments, the offset identifies an amount of time between a medium reservation operation performed by a hidden node, and a mitigation packet of a mitigation signal. In one example, the offset and the period of the mitigation packets is constant and remains fixed. Accordingly, the period of the mitigation packets may be determined based on the period of the medium reservation operations, and may be set to be the same as the medium reservation operations.

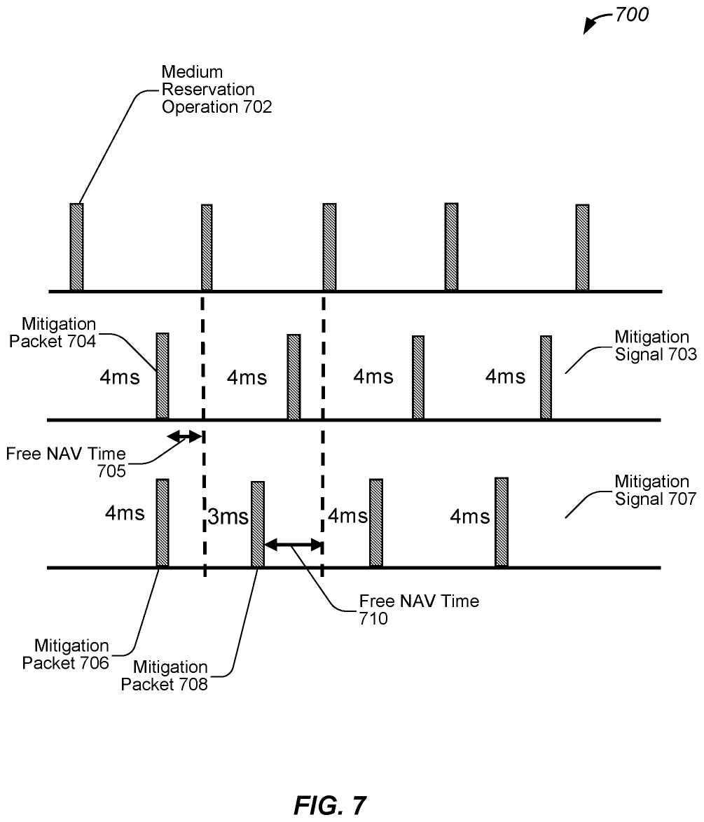

In various embodiments, the offset and the period of the mitigation packets is varied and may be modified to further increase data throughput. For example, an initial period may be determined for the mitigation signal, and the initial period may be dynamically modified if an observed data throughput does not increase by a designated amount. In an example as discussed above where a threshold value of a buffer is observed, if the storage level of the buffer does not return to above the threshold value, then one or more modifications may be made to the mitigation signal. For example, a period of the mitigation signal may be temporarily reduced, and then returned to the initial period. Additional details regarding such modification are discussed in greater detail below with reference to FIG. 7. It will be appreciated that any suitable measure or indicator of data throughput may be used to trigger modification of the mitigation signal. Moreover, other wireless connection parameters may be used to trigger modification of the mitigation signal, such as performance metrics of wireless channels. In various embodiments, parameters, such as the offset and period, may be determined by an entity, such as a manufacturer, based on testing during a design and manufacturing process.

Method 600 may perform operation 608 during which a mitigation signal may be generated. Accordingly, in response to determining an appropriate mitigation signal data pattern, a system component, such as a head unit, may generate a mitigation signal. As similarly discussed above, the mitigation signal is configured to have a designated periodicity as well as a designated duration of several mitigation data packets as specified by the appropriate data pattern generated during operation 606. As discussed above, such mitigation data packets are configured to clear a local NAV value, and cause a receiving device to switch to a different wireless channel.

Method 600 may perform operation 610 during which the mitigation signal may be transmitted. Accordingly, the head unit may transmit the mitigation signal to the wireless device to clear the local NAV value, and cause the device to switch to a different wireless channel. As discussed above, the mitigation signal includes mitigation packets forcibly sent in accordance with the designated data pattern. Accordingly, by forcing the device to clear a local NAV value and switch to a different wireless channel, effects of a medium reservation signal, which may include a long NAV packet, are mitigated due to termination of the NAV duration and switching to a different channel.

FIG. 7 illustrates an example of a timing diagram associated with medium usage enhancement, performed in accordance with some embodiments. Accordingly, diagram 700 illustrates one or more medium reservation operations, such as medium reservation operation 702, that may be performed by a hidden node. Such a hidden node may be an entity, such as a component of a telecommunications infrastructure, that periodically sends medium reservation requests, such as long NAV packets, to reserve a communications medium for its own data transmissions.

Diagram 700 also illustrates mitigation signal 703. As shown in FIG. 7, mitigation signal 703 includes multiple mitigation packets, such as mitigation packet 704 sent at a fixed period of 4 ms. The mitigation packets clear the NAV of a receiving wireless device, thus resulting in free NAV time, such as free NAV time 705. Accordingly, as shown in FIG. 7, free NAV time 705 represents an amount of time that the wireless device receiving the mitigation packet has enabled for its own data transmissions in response to receiving the mitigation packet. More specifically, if no mitigation packet was received, free NAV time 705 would otherwise be reserved for data transmissions of the hidden node, and the wireless device, which may be a smartphone, would not be able to communicate with another component, such as a head unit, during this time. In response to receiving the mitigation packet, free NAV time 705 has been recovered and is now available for communication with the head unit.

Diagram 700 further illustrates mitigation signal 707. As shown in FIG. 7, mitigation signal 707 includes multiple mitigation packets, such as mitigation packet 706 and mitigation packet 708, which are also sent periodically. However, as shown in FIG. 7, the period preceding mitigation packet 708 has been reduced to 3 ms, thus resulting in a longer free NAV time, as shown by free NAV time 710. Accordingly, in response to detecting one or more wireless connection parameters, such as a continued decrease in data throughput as discussed above, the period of mitigation signal 707 was dynamically modified and reduced from 4 ms to 3 ms to increase the duration of free NAV time 710, and further increase the amount of time recovered for communication between the receiving wireless device and another entity, such as a head unit. As additionally shown in FIG. 7, the period is then restored to 4 ms to maintain the new duration of the free NAV time. In this way, one or more features of the mitigation signal may be dynamically modified to further improve data throughput and efficiency of usage of the communications medium.

Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A method comprising:
monitoring, using one or more processing elements, one or more data throughput metrics associated with a first wireless device;
identifying, using the one or more processing elements, a presence of medium reservation activity associated with a second wireless device;
generating, using the one or more processing elements, a mitigation signal based, at least in part, on a designated data pattern, the mitigation signal comprising a plurality of mitigation data packets configured to reduce medium reservation by the first wireless; and
transmitting the mitigation signal to the first wireless device.

2. The method of claim 1, wherein the mitigation signal causes a reset of a local network allocation vector (NAV) value, and is further causes the first wireless device to switch wireless channels.

3. The method of claim 1, wherein the identifying of the presence of the medium reservation activity further comprises:
identifying a threshold value crossing based on the one or more data throughput metrics of the first wireless device, wherein the threshold value crossing is identified based on a status of an application buffer.

4. The method of claim 3, wherein the application buffer is included in a communications application executed by the first wireless device.

5. The method of claim 1, wherein the identifying of the presence of the medium reservation activity is performed based, at least in part, on location data associated with the first wireless device.

6. The method of claim 5 further comprising:
comparing the location data with designated location information associated with the second wireless device.

7. The method of claim 1, wherein the generating of the mitigation signal further comprises:
generating a mitigation signal data pattern identifying a timing of the plurality of mitigation data packets.

8. The method of claim 7 further comprising:
dynamically modifying a period of at least some of the plurality of mitigation packets included in the mitigation signal.

9. The method of claim 8, wherein modifying of the period of at least some of the plurality of mitigation packets is performed responsive to determining that a data throughput associated with the first wireless device is less than a designated threshold value.

10. A system comprising:
a transceiver configured to transmit and receive data compatible with a wireless communications protocol;
a processing device coupled to the transceiver and configured to:
monitor one or more data throughput metrics associated with a first wireless device;
identify a presence of medium reservation activity associated with a second wireless device;
generate a mitigation signal based, at least in part, on a designated data pattern, the mitigation signal comprising a plurality of mitigation data packets configured to reduce medium reservation by the first wireless; and
transmit the mitigation signal to the first wireless device.

11. The system of claim 10, wherein the mitigation signal is configured to cause a reset of a local network allocation vector (NAV) value, and is further configured to cause the first wireless device to switch wireless channels.

12. The system of claim 10, wherein the processing device is further configured to:
identify the presence of medium reservation activity based on a threshold value crossing, wherein the threshold value crossing is identified based on the one or more data throughput metrics of the first wireless device, wherein the threshold value crossing is identified based on a status of an application buffer, and wherein the application buffer is included in a communications application executed by the first wireless device.

13. The system of claim 10, wherein the identifying of the presence of the medium reservation activity is performed based, at least in part, on location data associated with the first wireless device, and wherein the processing device is further configured to:
compare the location data with designated location information associated with the second wireless device.

14. The system of claim 10, wherein the processing device is further configured to:
generate a mitigation signal data pattern identifying a timing of the plurality of mitigation data packets.

15. The system of claim 10, wherein the processing device is further configured to:
dynamically modify a period of at least some of the plurality of mitigation packets included in the mitigation signal, wherein the modifying of the period of at least some of the plurality of mitigation packets is performed responsive to determining that a data throughput associated with the first wireless device is less than a designated threshold value.

16. A device comprising:
processing elements configured to:
monitor one or more data throughput metrics associated with a first wireless device;
identify a presence of medium reservation activity associated with a second wireless device;
generate a mitigation signal based, at least in part, on a designated data pattern, the mitigation signal comprising a plurality of mitigation data packets configured to reduce medium reservation by the first wireless; and
transmit the mitigation signal to the first wireless device.

17. The device of claim 16, wherein the mitigation signal is configured to cause a reset of a local network allocation vector (NAV) value, and is further configured to cause the first wireless device to switch wireless channels.

18. The device of claim 16, wherein the processing elements are further configured to:
identify the presence of medium reservation activity based on a threshold value crossing, wherein the threshold value crossing is identified based on the one or more data throughput metrics of the first wireless device, wherein the threshold value crossing is identified based on a status of an application buffer, and wherein the application buffer is included in a communications application executed by the first wireless device.

19. The device of claim 16, wherein the identifying of the presence of the medium reservation activity is performed based, at least in part, on location data associated with the first wireless device, wherein the processing device is further configured to:
compare the location data with designated location information associated with the second wireless device.

20. The device of claim 16, wherein the processing device is further configured to:
generate a mitigation signal data pattern identifying a timing of the plurality of mitigation data packets; and
dynamically modify a period of at least some of the plurality of mitigation packets included in the mitigation signal, wherein the modifying of the period of at least some of the plurality of mitigation packets is performed responsive to determining that a data throughput associated with the first wireless device is less than a designated threshold value.
